(19) United States
(12) Patent Application Publication
(10) Pub. No.: US 2009/0266237 A1
(43) Pub. Date: Oct. 29, 2009

(54) Membrane for Gas Phase Separation and Suitable Method for Production Thereof

(76) Inventors: Jose Manuel Serra Alfaro, Valencia (ES); George Johannes Wilhelmus Van Der Donk, Venray (NL); Wilhelm Albert Meulenberg, Vijlen (NL); Detlev Stover, Niederzier (DE); Hermann Gies, Goslar (DE)

Correspondence Address: K.F. ROSS P.C., 5683 RIVERDALE AVENUE, SUITE 203 BOX 900, BRONX, NY, 10471-0900, US

(21) Appl. No.: 11/887,816

(22) PCT Filed: Apr. 1, 2006
(86) PCT No.: PCT/DE2006/000593

§ 371 Date: Jun. 2, 2009

(30) Foreign Application Priority Data
Apr. 8, 2005 (DE) 10 2005 016 397.1

(51) Int. Cl. B01D 53/02; B05D 5/00

(52) U.S. Cl. 96/154; 427/244

(57) ABSTRACT

The invention relates to a method for the hydrothermal production of a microporous membrane. According to said method, a colloidal solution comprising zeolite frameworks with 4-ring, 6-ring, and/or 8-ring pores which are provided as crystallites whose size ranges from 2 to 25 nm is applied to a porous substrate with the aid of a wet application technique. The applied layer is contacted with a hydrothermal liquid, and a nanocrystalline, microporous zeolite layer having an average pore diameter of 0.2 to 0.45 nm is synthesized at temperatures ranging between 50 and 250° C. and at an autogenous pressure. Such a microporous membrane comprising a porous substrate and at least one nanocrystalline zeolite layer that is disposed thereupon and has an average pore diameter of 0.2 to 0.45 nm is advantageously suitable for use as a separating device for gas phase separation, making it possible to separate particularly N₂O₂, N₂/CO₂, H₂/CO₂, or CO₂/CH₄ gas mixtures. Said separating device is especially temperature-resistant and can therefore be integrated directly into thermal processes.

The invention relates to a membrane for gas-phase separation and to a method for producing such a membrane.

### PRIOR ART

Approximately 80% of the energy used worldwide is generated through the conversion of fossil energy sources. A not inconsiderable emission of CO₂ is associated therewith that is suspected as the cause of global warming of the earth. The primary goal is therefore to reduce the CO₂ emission directly at the point of the energy generators, or to avoid it completely.

For purposes of separating CO₂ in power plant processes using fossil primary energy sources, there exist in principle three systems:

a) Separation After Energy Conversion:

Through the use of complex equipment and chemical treatment, the CO₂ of low concentration here is removed from the slightly temperature-adjusted flue gas stream of the energy conversion systems (separation problem: CO₂/N₂).

b) Oxygen Combustion:

The use of pure oxygen in place of air as the oxidizing agent for combusting the gas or coal results in a flue gas highly enriched in CO₂ having only low nitrogen components and from which the CO₂ is significantly easier to remove than under point a). The disadvantageous aspect is that pure oxygen must first be obtained (separation problem: air separation: O₂/N₂).

c) Decarbonization Before Energy Conversion:

Here the carbon is removed from the fossil fuel before the actual combustion whereby the fuel, in particular, coal, is converted by means of partial oxidation or reforming into CO₂ and hydrogen gas (separation problem: CO₂/H₂); combustion of hydrogen. The CO₂ can be scrubbed by physical or chemical scrubbing solutions. Here too, the separation of the CO₂ from the gas mixture proves to be easier than as described under point a) since here as well significantly higher concentrations and pressures for the CO₂ are present.

All of the above-referenced systems have in common that a significant reduction in thermal efficiency results and complex equipment is required that thus also makes these energy conversion methods with reduced CO₂ discharge more cost-intensive. Heretofore, however, neither solid adsorbents, nor porous membranes, nor zeolite beds or membranes have been suitably capable of effecting this kind of gas separation in a cost-effective manner at an appropriate scale.

Ceramic, Microporous Membranes

One potentially suitable method entailing significantly lower efficiency losses is gas separation by means of ceramic microporous membranes. Ceramic membranes have high chemical and thermal stability and can be employed in all three power plant systems. However, existing microporous membranes do not yet achieve the pore size diameters required for gas separation, have insufficient permeation or separation rates, or are unstable under process conditions. Here the permeation rate constitutes the volumetric flow rate per time unit of the permeating component relative to the membrane surface and the applied partial pressure differential across the membrane [m³/m² hbar]. The selectivity is described by the so-called separation factor given by the ratio of the permeation rate of the gases to be separated. A precise setting of the microstructure in the nanometer range is desirable here in order to be able to achieve higher values.

For purposes of gas separation, both planar as well as tubular concepts exists in which generally a graduated layer structure is present. Starting with a mechanically stable macroporous substrate (pore diameter 50-100 nm), different methods apply multiple mesoporous (50>dₚₒᵣₑ>2 nm) and microporous (dₚₒᵣₑ>2 nm) layers.

Zeolite Membranes

Zeolite membranes are crystalline microporous, inorganic membranes. The driving forces for separation are the affinity of the permeating molecules relative to the zeolite material, on the one hand, and the difference between molecule sizes and pore diameters of the membrane, on the other hand. The best investigated membranes belong to the MFI type, mordenite, and zeolites A and Y having already been studied. In terms of being suited in principle for gas-phase separation, zeolites of the faujasite type (Y, X and K) are also described in the literature.

With the microporous separating membranes, a differentiation is made between crystalline zeolitic membranes of the system SiO₂-Al₂O₃ and amorphous ones of the system SiO₂-Al₂O₃, TiO₂, ZrO₂. With crystalline membranes, it is primarily defects in the layers (intercrystalline pores, defects) or excessively large pore diameters that are the reason for an insufficient separation rate.

Currently, there exists a growing interest in thin “defect-free” zeolite layers for special separation applications. However, the pore sizes of existing zeolite membranes reported in the literature are larger than 0.5 nm and are currently employed, e.g. to separate liquids, and thus have only a limited capability for gas separation of small molecules. Nevertheless, due to their differing adsorption properties for different gases, zeolites are well suited for purposes of separation, even though the lattice openings are too large for the molecular sieving of gases. In addition, zeolite structures with smaller lattice openings are suitable for molecular sieving as long as defect-free layers are present.

Production of Zeolite Membranes

A variety of technologies are documented for producing zeolite membranes:

a) infiltration of zeolite crystals into a matrix (polymer, metal);

b) in situ hydrothermal synthesis on an existing substrate (e.g. porous ceramic);

c) impregnating a porous matrix with synthesis solution and its crystallization within the pores; and

d) employing two-stage secondary crystal growth.

Generally, zeolites are hydrothermally synthesized. In the presence of a structure director, structure directing agent (SDA), which is responsible for forming the pores in the specified manner, zeolites crystallize at approximately 100-200° C. from aqueous solutions under autogenous pressure. Suitable SDAs include, in particular, quaternary ammonium salts that decompose during calcination and are released, thereby making the pore space accessible. There have been controversial discussions for many years about the mechanism of crystallization, in particular, about the role of precursors that are the to form in the homogeneous solution interacting with the silicic acid. By varying the Si/Al ratio of the precursor solution, the concentration of the ingredients, the pH value, and the choice of the SDA, it is possible to influence the structure during the synthesizing process and the properties of the zeolite.

The above-referenced systems are employed for a multiplicity of zeolite framework types. Application in the area of gas separation has failed up until now due to the fact that defect-free membrane production can be implemented only with great difficulty, with the result that it was not possible to achieve adequate separation factors. Intercrystalline defects of the layer were the main source of defects here. During the production of zeolite membranes by in situ hydrothermal synthesis, multiple layers of oriented crystals are generated. Here too, intercrystalline defects are generally found. The resulting layer thickness is generally still several 10s of μm, with the result that the permeability of the membrane is reduced.

By precisely introducing seed crystals on the substrate, it is possible to influence seed growth. One possible known method for applying the seed crystals on the substrate surface is mechanically smearing the seed crystals into the surface by means of cationic polymers. In addition, crystals are supplied directly onto the substrate as an alcohol dispersion, or via sols comprising silicon compounds, water, bases, structure directors, as well as aluminum salt. The use of these sols is termed secondary seed growth. The substrate is then coated with a zeolite layer, (e.g. by means of dip coating), and then treated hydrothermally. In the process a layer thickness of approximately 200 nm is created. This secondary growth process of the zeolite seeds provides for a precise control of the microstructure by de-coupling seed formation and seed growth.

Object and Solution

The object to be attained by the invention is to provide a separating device for gas-phase separation with porosities in the range of 0.2-0.45 nm, by means of which it is possible to separate, in particular, N₂/O₂, N₂/CO₂, H₂/CO₂, or also CO₂/CH₄ gas mixtures. In particular, this separating device should be directly integratable in thermal processes and thus be especially temperature-stable.

In addition, the object to be attained by the invention is to create a method for producing such a device.

The objects of the invention are attained by a membrane comprising the totality of the features indicated in the main claim, as well as by a production method for such a membrane as indicated in the dependent claim. Advantageous embodiments of the device and of the method are found in the respective related claims.

### SUMMARY OF THE INVENTION

Within the scope of the invention, it was discovered that a separating device suitable for gas separation can be obtained by an as-much-as-possible defect-free ceramic membrane composed of zeolite structures, in which membrane a nanostructured framework structure having porosities in the range of 0.2-0.45 nm can be set by precise modification of the initial reagents and production parameters, and subsequent post-treatment.

The invention relates to a method for producing crystalline, microporous, nanoscale, ceramic layer systems, as well as a separating device producible thereby, in particular, for application as a gas separation membrane in fossil-fuel power plants.

The membrane according to the invention comprises a nanocrystalline zeolite layer provided on a porous substrate, the layer having an average pore diameter of 0.2 to 0.45 nm.

The membrane according to the invention comprises a nanocrystalline zeolite layer provided on a porous substrate and having an average pore diameter of 0.2 to 0.45 nm. Suitable zeolite structures here are, besides zeolite frameworks with 4-ring pores, those as well with 6-ring and/or 8-ring pores that generally have the required small pore sizes in the range of 0.2 to 0.45 nm. The zeolites suitable for this application are generally pure silicon zeolites. Within the scope of the invention, however, those are also included that can additionally have small quantities of Al₂O₃, TiO₂, Ti₂O₅, Fe₂O₃, GeO₂, B₂O₃, Ga₂O₃, or other metals. The quantities involved here, however, are so small that they have no effect at all on the effectiveness of the zeolite layer.

Suitable zeolite framework structures include, for example, DDR, DOH, LTA, SGT, MTN, and SOD, as well as mixtures of these structures. The zeolite layer thus generally has significantly smaller pore sizes than do known MFI zeolites with a pore size greater than 0.55 nm.

In addition to the mere pore size of the zeolite layer of the membrane according to the invention, which is in particular responsible for selectivity, it is the structure, in particular, the freedom from defects of the crystalline zeolite layer that is the decisive factor for use as a gas separation membrane. It is only with a layer having few defects that it is possible to achieve an optimum between permeation and selectivity even when given a small layer thickness. The membrane according to the invention has at least one crystalline zeolite layer with a layer thickness of 50 nm up to 2 μm.

The nanocrystalline zeolite layer of the membrane according to the invention is provided on a porous substrate that generally has a average pore size of 2 nm up to 2 μm, and comprises, for example, steel, aluminum, titanium, silicon, zirconium, alumosilicates, or even cerium, as well as mixtures thereof.

To produce the above-referenced nanocrystalline zeolite layer, the method according to the invention employs a colloidal initial solution and its metastable complexes that comprise zeolites in the form of nanocrystals as membrane precursors. These zeolite precursors are applied to a mesoporous substrate by means of a wet deposition process, such as, for example, spin coating, dip coating, wet power spraying, and screen printing. In a subsequent hydrothermal treatment, the layer is converted to a crystalline microporous zeolite layer with pore sizes between 0.2 nm up to 0.5 nm.

Initially here a colloid composed of water, a silicon compound and a structure director is produced. Suitable silicon compounds are organic silicon compounds, such as, for example, tetraethyl orthosilicate (TEOS), or also tetramethyl orthosilicate (TMOS), or also inorganic silicon compounds such as silicon dioxide, a silica gel, or colloidal silicon. The structure director (SDA=structure directing agent) can be, for example, an organic hydroxide, preferably, quaternary ammonium hydroxide, such as, for example, tetraethyl ammonium hydroxide, benzyl trimethyl ammonium hydroxide, or the like. In addition, the colloidal solution can also contain alcohols. The colloidal solution here advantageously has zeolite crystals with a size between 2 and 25 nm, in particular, between 2 and 15 nm.

The colloidal solution is applied to the porous substrate, whereby it is possible to employ typical wet application techniques such as spin coating, dip coating, screen printing, or spray techniques. As a result of a thick application, crystalline particles are created having a size between 2 and 20 nm.

The actual synthesis of the crystalline zeolite layer is effected hydrothermally at temperatures between 50 and 250° C. and under autogenous pressure. The pH value is set above 9. Alternatively, the pH value can be lower than 9 (e.g. 7) if fluoride anions are present in the hydrothermal solution. The composition of the hydrothermal solution must have at least have water; however, optionally, it can also have a base, F ions, SDA, or silicon compounds. After several hours, the formation of the crystalline zeolite layer then takes place.

In particular, the method according to the invention has the following advantages:
The use of nanocrystalline colloids allows for the production of an essentially defect-free membrane that has only a very small number of cracks or holes in the microporous layer.
The combination of the use of nanocrystalline colloids and an appropriately selected deposition technique advantageously allows the variation of the zeolite layer such that the permeation flow, and thus the separation factor, can be optimized.
The zeolite coating can be used directly as a separating membrane, or can be generated by recrystallization and re-growth during a hydrothermal treatment.

### SPECIFIC DESCRIPTION

The kinetic diameters of the gases to be separated are generally determined by the pore size of the zeolite framework types that are especially suitable for the separation problem. For the above-mentioned N₂/O₂, N₂/CO₂, or also H₂/CO₂ gas mixtures, the kinetic diameters of the gases to be separated are around d_{kinH2}=2.89 Å, d_{kinCO2}=3.3 Å, d_{kinO2}=3.46 Å, d_{kinN2}=3.64 Å, d_{kinCH4}=3.8 Å. For zeolites with 8-ring pores, and thus a pore opening of approximately 0.4 nm, the molecular sieve effect and the sorption behavior can be exploited. 10-ring pores with a width of approximately 0.55 nm provide even better diffusion properties for mass transfer, however at the expense of the molecular sieve effect. Suitable zeolite frameworks that have pore openings of approximately 0.2 to 0.5 nm, and thus should in principle have the required selectivity, are therefore to be found in particular in the 4-ring, 6-ring, or even 8-ring zeolite structures.

In addition to pore diameter, however, the pore network also plays a critical role. In the case of zeolite framework types with a three-dimensionally networked pore system, the orientation of the crystals on the substrate interface plays only a secondary role. Lower-dimensional pore systems, on the other hand, require an oriented deposition of the zeolite frameworks in order to achieve the optimal separation effect and optimal transport performance.

Out of the multiplicity of zeolite framework structures, it is in particular the zeolite types DDR, DOH, LTA, SGT, MTN, SOD, CHA, as well as mixtures thereof, that have proven to be especially well-suited.

Most of the zeolite framework structures can be flexibly modified in their composition. In the case of the proposed framework types, hydrophobic pure SiO₂ frameworks can be synthesized that by replacing Si at the tetrahedral position with trivalent cations such as Al, B, Fe and others can become increasingly hydrophilic, and contain non-framework cations for charge compensation. These are then available for ion-exchange reactions, or constitute in the protonated form the reactive centers in the acidically catalyzed reactions. Adsorption is also affected by the charge of the elementary cell. Molecular sieving is predominantly found in zeolites with pore sizes in the range of 0.3-0.5 nm.

The invention relates to a method for the hydrothermal production of a microporous membrane in which a colloidal solution comprising zeolite frameworks with 4-ring, 6-ring, and/or 8-ring pores, which are present in the form of crystallites of a size between 2 and 25 nm, are applied by means of a wet application technique to a porous substrate. The applied layer is brought into contact with a hydrothermal liquid; and at temperatures between 50 and 250° C. and under autogenous pressure, a nanocrystalline microporous zeolite layer is synthesized that has an average pore diameter of 0.2 to 0.45 nm.

Such a microporous membrane comprising a porous substrate and at least one nanocrystalline zeolite layer provided thereon having a pore diameter of 0.2 to 0.45 nm is advantageously suited to be employed as a separating device for a gas-phase separation, by means of which it is possible to separate, in particular, N₂/O₂, N₂/CO₂, H₂/CO₂, or even CO₂/CH₄ gas mixtures. This separating device is in particular temperature-stable, and is thus directly integratable in thermal processes.

1-19. (canceled)

20. A method for hydrothermally producing a microporous membrane comprising a porous substrate and a zeolite layer provided thereon, the method comprising the following steps:
applying by means of a wet application technique a colloidal solution that has at least water, a silicon compound, a structure director, and zeolite crystals of a size between 2 and 25 nm to the porous substrate;
contacting the applied solution with a hydrothermal liquid; and
at temperatures between 50 and 250° C. and under autogenous pressure, synthesizing from the solution a nanocrystalline, microporous zeolite layer having an average pore diameter of 0.2 to 0.45 nm.

21. The method defined in claim 20 wherein a colloidal solution is employed having zeolite frameworks with 4-ring, 6-ring and/or 8-ring pores.

22. The method defined in claim 20 wherein a hydrothermal liquid is employed that additionally has a silicon compound or a cationic tenside as a structure director or a base.

24. The method defined in claim 20 wherein a hydrothermal liquid is employed having a pH above 9.

25. The method defined in claim 20 wherein the zeolite layer is applied with a layer thickness between 50 nm and 5 μm.

26. The method defined in claim 20 wherein a porous substrate is employed comprising steel, aluminum, titanium, silicon, zirconium, alumosilicate, cerium, or a mixture thereof.

27. The method defined in claim 20 wherein a porous substrate with an average pore diameter between 2 nm and 2 μm is employed.

28. In a microporous membrane comprising a porous substrate and a zeolite layer provided thereon, the improvements wherein:
the zeolite layer is a nanocrystalline zeolite layer and comprises crystallites of a size between 2 and 20 nm;
the zeolite layer has an average pore diameter of 0.2 to 0.45 nm; and
the zeolite layer has a layer thickness between 50 nm and 2 μm.

29. The microporous membrane defined in claim 28 wherein the zeolite layer has zeolite frameworks with 4-ring, 6-ring, and/or 8-ring pores.

30. The microporous membrane defined in claim 28 wherein zeolite layer comprises DDR, DOH, LTA, SGT, MTN, SOD, CHA, or a mixture thereof.

31. The microporous membrane defined in claim 28 wherein the zeolite layer also has small quantities of Al₂O₃, TiO₂, Ti₂O₅, Fe₂O₃, GeO₂, B₂O₃, Ga₂O₃.

32. The microporous membrane defined in claim 28 wherein the porous substrate comprises steel, aluminum, titanium, silicon, zirconium, alumosilicate, cerium, or a mixture thereof.

33. The microporous membrane defined in claim 28 wherein the porous substrate has an average pore diameter between 2 nm and 2 μm.
